(19) United States
(12) Patent Application Publication
(10) Pub. No.: US 2026/0158962 A1
(43) Pub. Date: Jun. 11, 2026

(54) Monitoring the Use of Energy Stored in an Electric Vehicle

(71) Applicant: Bayerische Motoren Werke Aktiengesellschaft, Muenchen (DE)

(72) Inventors: Sascha BRINKMANN, Muenchen (DE); Alexander FUNKE, Baldham (DE)

(21) Appl. No.: 19/150,124

(22) PCT Filed: Jan. 22, 2024
(86) PCT No.: PCT/DE2024/100047

§ 371 Date: Jul. 22, 2025

(30) Foreign Application Priority Data
Jan. 23, 2023 (DE) 10 2023 101 524.9

(51) Int. Cl. B60L 58/12; B60L 53/14; B60L 53/66; B60L 55/00; G06Q 30/04; G06Q 50/06

(52) U.S. Cl. CPC B60L 58/12; B60L 53/14; B60L 53/665; B60L 55/00; G06Q 30/04; G06Q 50/06

(57) ABSTRACT

A method for monitoring electric energy use stored in an electric vehicle storage device, wherein the quantity of electric energy discharged from the energy storage device and the existing charging connection state to a charging point are monitored, and the quantity of energy fed back from the energy storage device by a charging point is determined in that the quantity of energy discharged from the energy storage device is monitored when the electric vehicle is connected to a charging point. A system includes an electric vehicle that can be charged in a bidirectional manner and includes a vehicle electricity meter to measure the electric energy discharged from the energy storage, a charging point for bidirectional charging, and an external cost-calculating entity that receives information on energy quantities passing through the vehicle electricity meter and charging connection states and calculates energy quantity passing through the meter based on usage type.

### BACKGROUND AND SUMMARY

The present disclosure relates to a method for monitoring the use of electrical energy stored in an electrical energy store of an electric vehicle, wherein the quantity of electrical energy which is discharged from the energy store is monitored. The present disclosure also relates to a system for executing the method. The present disclosure is particularly advantageous for V2X applications.

If a customer employs energy in their household, e.g. for cooking, heating or charging their electric vehicle, this energy is metered at a transfer point between the electric power grid and the customer installation. This metering is executed by an electricity meter which is installed at this point, and forms the basis for billing. As this involves an end user installation, the customer is required to settle the full electricity price, which is proportionally comprised of the generation price, network access charges, taxes and duties.

However, other installations exist, such as e.g. pumped storage power plants or large stationary battery stores, which are employed for grid stabilization, or are otherwise employed for market-related purposes. According to their usage pattern, these installations are classified, for regulatory purposes, as consumers or generators on the electric power grid. Accordingly, they can both extract energy from the grid, and execute the re-injection thereof. A precondition for the cost-effective operation of these installations is that, for the execution of their grid stabilization function, they are not subject to the same conditions as an end user installation. This means that they are classed as intermediate storage facilities, and are thus not classified as final consumers or end users. As a result, energy which they extract from the grid is not subject to the customary charges which are applied to final consumption (e.g. with respect to network access charges and levies).

Electric vehicles, which are capable of executing bidirectional charging, can assume the same function as a stationary battery store on the grid. By a corresponding control function, electric vehicles can thus contribute, for example, to grid stabilization or, on the basis of market price indicators, can reinject energy extracted back into the grid. Via this facility, electric vehicles assume two functions. The primary application remains the provision of personal mobility for the user. The secondary application is the employment of the vehicle to serve the interests of the grid or the market during periods in which the vehicle is parked and is connected to the electric power grid via a charging point. It is known that vehicles are parked for many hours during the day. During this time, in a plugged-in or ready-to-charge state, vehicles could potentially deliver a substantial contribution to grid stabilization and load relief on the electricity market. In particular, this might be significant in the event that increasing numbers of volatile power generating facilities, such as wind power and PV installations, are brought on-grid.

The majority of these electric vehicles are charged using customer installations in which, for the extraction of energy from the electric power grid, it is necessary for the full electricity price to be settled. If energy stored in electric vehicles is employed for driving, this is a comprehensible arrangement. However, if electrical energy from the battery, for example for the purposes of grid stabilization or in response to price indicators, is to be injected back into the electric power grid, this is a loss-making transaction for electric vehicle users, on the grounds that the latter, in consideration of this injection, receive the generation price only, and network access charges, taxes and duties which are chargeable to end users are not refunded.

It is therefore desirable to implement a billing system which takes account of the employment of energy which is stored in the drive battery. If energy is employed for the purposes of mobility, the user is required to complete settlement in respect thereof at the full electricity price. However, if energy is re-injected, this energy should be exempt from network access charges, taxes and duties. Consequently, settlement in respect of energy which is stored in a drive battery is only completed upon the employment thereof, with an offset vis-á-vis the time of extraction. If this option is to be exercised, the application for which energy has been extracted from the drive battery must be unequivocally classifiable. One option is the fixed segmentation of the drive battery. One section of the drive battery is employed exclusively for applications involving re-injection or services for supporting the grid. Another section is employed exclusively for the purposes of mobility. However, this fixed division is detrimental to the overall capacity of the drive battery. Although this would be perceived by the user in the form of a reduced range of the vehicle, the potential for applications in support of the grid would also be correspondingly restricted.

U.S. Pat. No. 9,337,679 B2 discloses a charging system for electric vehicles, in which the charging station and the vehicle respectively comprise a power transmission metering unit and a communication system for communicating data, at least from the vehicle to the charging station. Power output is controlled on the basis of a comparison of power transmission measurements, which measurements are executed by the charging station and by the control system of the electric vehicle.

U.S. Pat. No. 11,091,055 B2 discloses vehicle charging systems and control logic functions for the provision of vehicle-grid integration (VGI) operations, methods for the production/employment of charging systems of this type, and electrically powered vehicles having intelligent vehicle charging and VGI capabilities. One method for controlling charging processes of electric vehicles comprises a vehicle controller which detects whether a vehicle is coupled to an electric vehicle supply equipment or EVSE, and determines whether the present mileage capacity of the vehicle exceeds a calibrated mileage capacity threshold value. In response to the connection of the vehicle to the EVSE, and an overshoot of the calibrated mileage capacity threshold value by the present mileage capacity of the vehicle, the controller determines the present remaining service life of the drive battery of the vehicle and the present operating time of the vehicle. The vehicle controller determines whether the present remaining battery service life exceeds a predicted remaining battery service life which corresponds to the present operating time. If this is the case, the vehicle controller of the drive battery enables electric power to be transmitted to the EVSE.

US 2012/0229085 A1 discloses a system for charging batteries of electric vehicles on public facilities, such as street lights and parking meters. The system comprises a modification of the facility mounting, for the conversion thereof into a vehicle battery charging station, wherein a power interface module is employed which incorporates an electrically coded power output socket, which socket is connectable to the electric power grid which supplies the facility mounting with power. The system comprises a complementarily coded plug, the insertion of which into the power output socket is required, in order to access electrical energy from the socket, wherein the plug is arranged at the input end of the vehicle charging cable, the output end of which terminates at a vehicle-mounted cable. By a charging control system which executes a charging current protection function, it is enabled that a charging current only flows from the charging socket to batteries within the vehicle in the event that a charging authorization prepayment device is present. For example, a magnetically or electronically coded charging card is introduced into a charging station access authorization device such as, for example, a card reader which is installed in the vehicle.

An object of the present disclosure is to at least partially surmount the disadvantages of the prior art and, in particular, to provide a facility for the simple and user-dependent balancing of charging energy delivered to a drive battery of an electric vehicle which is connected to a charging point.

This object is fulfilled by the features disclosed herein. In particular, preferred embodiments can also be inferred from the present disclosure.

This object is fulfilled by a method for monitoring a use of electric energy which is stored in an electrical energy store of an electric vehicle, wherein a quantity of electrical energy which is discharged from the electrical energy store and an existing charging connection status to a charging point are monitored, and a quantity of energy which is re-injected from the energy store via a charging point is determined, wherein the quantity of electrical energy which is discharged from the energy store is monitored when the electric vehicle is connected to a charging point.

This method provides an advantage, in that a reliable monitoring is enabled as to whether a quantity of electrical energy which is stored in an energy store of an electric vehicle is employed for operating the electric vehicle, or is re-injected into an electric power grid. This enables a balancing of the quantity of energy which is re-injected and the execution of billing under conditions which are applicable to intermediate stores, e.g. wherein network access charges, taxes and duties which are levied on end users are waived or refunded. The user of the electric vehicle can thus employ their electric vehicle both for electromobility and for purposes which serve the interests of the grid and/or the market. As balancing is flexible, according to usage, no disadvantages are sustained by the user in conjunction with usage, of the type which would apply e.g. in the event of the partitioning of the store. Motivation for a user of the electric vehicle to make the drive battery of the vehicle available for re-injection is enhanced as a result, which enhancement, in turn, improves grid stability. A further advantage is provided, in that the method can be employed on numerous different charging points having different functionalities.

Usage corresponds to the type of usage, either for the operation of the electric vehicle, or for re-injection from the vehicle, particularly into an electric power grid. This usage can comprise V2G (“vehicle-to-grid”) and V2H (“vehicle-to-home”) applications and, in general, V2X (“vehicle-to-anything”) applications.

The electric vehicle can be, for example, a plug-in hybrid vehicle (PHEV), or a fully electrically powered vehicle, e.g. a battery electric vehicle (BEV). The electric vehicle can be e.g. a passenger car, a heavy goods vehicle, a bus, a motorcycle, etc.

The energy store, in particular, is a battery (e.g. a lithium-ion battery), in particular a traction or drive battery.

The electric vehicle can be connected or coupled to a charging point, by a cable or inductively. The charging point can be e.g. a wall box or a charging station. In particular, the charging point can be designed to meter the quantity of electrical energy flowing therein, particularly in a bidirectional manner. According to a further development, the charging point and the electric vehicle are capable of mutual communication.

The charging connection status can assume the following states: “connected” and “not connected”. It can be assumed that, in the connected state, the vehicle is not traveling.

Monitoring of a quantity of energy can comprise a metering or determination of the quantity of energy.

Determination of the quantity of energy which is re-injected via the charging point can be executed such that it corresponds to the quantity of energy which is discharged from the energy store, when the electric vehicle is connected to a charging point, i.e. when the charging connection status assumes the “connected” state or status. In particular, it can thus be assumed that an energy consumption of electric loads of the electric vehicle is practically negligible. Alternatively, from the quantity of energy which is discharged from the energy store, a quantitative electricity consumption can be deduced, which consumption is determined e.g. by experiments, simulations or historical data. Knowledge of the quantity of energy re-injected enables a usage-dependent billing, e.g. for the redemption of previously settled network access charges, taxes and duties, or for the prevention of a settlement thereof.

According to one configuration, the quantity of electrical energy which is discharged from the energy store is monitored by an energy measuring device or electricity meter of the electric vehicle which is assigned to the energy store (a “vehicle electricity meter”) This advantageously enables a reliable monitoring of the quantity of energy which is discharged from the energy store. In particular, the vehicle electricity meter is a certified electricity meter.

According to one configuration, the vehicle electricity meter is electrically arranged between the energy store and electrical loads of the electric vehicle, such as e.g. a drive motor, an air-conditioning system and other electrical loads. This enables a particularly reliable monitoring of the quantity of energy which is discharged from the energy store.

According to one configuration, the vehicle electricity meter also monitors the quantity of energy which is injected into the energy store, wherein the vehicle electricity meter is thus a bidirectionally metering vehicle electricity meter. The quantitative throughflow of energy, and the associated direction of flow thereof, can thus be advantageously monitored, i.e. the quantity of energy associated with charging and the quantity of energy associated with discharging. This facilitates a billing of the energy consumption of the electric vehicle.

According to one configuration, the electric vehicle is designed to transmit metered values from the vehicle electricity meter and, optionally, the associated charging connection statuses, to an external billing entity. This further facilitates a billing of energy consumption. Metered values can be transmitted in the form of push data or pull data. Metered values can be transmitted as explicit values, or in the form of transmission units, e.g. message blocks, which correspond to specific quantities of energy. Metered values can be transmitted e.g. via a wireless communication interface of the vehicle, e.g. via the cellular radio modem thereof.

According to a further development, the external billing entity is a metering point operator, in particular the backend thereof. The metering point operator can be the operator of the vehicle electricity meter and, optionally, can also be the operator of a charging point electricity meter which is assigned to the charging point.

According to one configuration, in the event of a connection of the electric vehicle to a charging point, the quantity of energy which is re-injected via the charging point is monitored by a charging point electricity meter which is assigned to the charging point and, by a comparison of the quantity of energy which has been discharged from the energy store with the quantity of energy which has been re-injected via the charging point, a quantity of energy which has been consumed by the electric vehicle in the interim is determined. An advantage is thus achieved, in that a billing or balancing operation is rendered more accurate, on the grounds that an electricity consumption of the electric vehicle during a connection period to the charging point (e.g. for the operation of electronics, etc., which are required for the purposes of charging) can also be taken accurately into consideration. The quantity of energy consumed by the electric vehicle can also be employed as a historical value, in order to estimate a customary energy consumption, etc.

According to one configuration, metered values from the vehicle electricity meter are documented or balanced in a blockchain, and the blocks of the blockchain are communicated to the external billing entity. Cryptographic methods, which are a constituent element of a blockchain, advantageously protect information which is communicated by the blockchain against manipulation during the capture, storage and transmission thereof. The blockchain is a simple interlinked list, in which each block contains a proof of its predecessor. Together with this proof, a checksum for the content of the preceding block is also included. On the basis of this balancing operation, billing for the quantity of energy extracted by the user of the electric vehicle can be executed. Data from the blockchain can thus be incorporated in the balancing cycle of the electricity meter of the customer.

According to one configuration, one block contains a proof for a checksum of a content of a preceding block, which checksum is signed, or has been signed by the vehicle electricity meter, using the private key thereof. In particular, the checksum for one block is formed by all the data in this block. As a result, messages transmitted by the block or entry are protected against manipulation in a simple and particularly secure manner. An individual private key is thus assigned to the vehicle electricity meter, by which the latter can apply a signature to encrypted messages.

According to one configuration, at least the following entries are included in one block of the blockchain:
an unequivocal identification of the block;
an unequivocal identification of the electric vehicle and of the vehicle electricity meter;
an unequivocal identification of the charging station to which the vehicle is connected (in the connected state only);
the term of validity of the block, comprised of a start time and end time;
the charging connection status: connected (“charging”) or not connected (“driving”);
the direction of energy flow: for charging or discharging the energy store;
the quantity of energy charged or discharged;
proof of the temporally preceding block, in the form of the unequivocal identification of the preceding block;
a checksum for the entries listed above, signed using the private key of the sub-meter.

According to one configuration, the blockchain is progressively generated by the vehicle electricity meter, in particular at regular intervals.

According to one configuration, one entry or one block in the blockchain is generated for each partially completed and stipulated quantitative unit of energy throughput, e.g. 1 kWh. This enables a particularly simple implementation and evaluation. According to this configuration, a block of the blockchain which is presently still open is closed, immediately the stipulated quantitative energy throughput is achieved. A new entry or block can then be generated.

According to one configuration, in the event of a changeover of the charging connection status and/or in the event of a changeover in the direction of energy flow, the quantitative proportion of energy is balanced, and the block of the blockchain which is presently still open is closed. Thereafter, a new entry or block having the new status can then be generated.

The last two above configurations can be implemented such that a presently open block in the blockchain is closed in the event that a) the stipulated quantitative energy throughput is achieved, or b) a changeover of the charging connection status and/or of the direction of energy flow occurs. Detectable combinations with respect to b) can comprise, for example, the following combinations:
connected and charging (=charging)
connected and discharging (=re-injection)
not connected and discharging (=vehicle operation, e.g. driving)
not connected and charging (=recuperation).

The object is also fulfilled by a system comprising:
a bidirectionally chargeable electric vehicle having an electrical energy store and a vehicle electricity meter, which is designed for metering at least a quantity of electrical energy which is discharged from the energy store;
a charging point which is designed for the bidirectional charging of the electric vehicle;
an external billing entity, which is communicatively connectable to the electric vehicle and is designed to receive information on the throughput of quantities of electrical energy in the vehicle electricity meter;
and which is designed to execute a billing of the quantitative energy throughput in the vehicle electricity meter, according to the energy usage of type of energy usage specified.

The system can be configured in an analogous manner to the method, and vice versa, and assumes the same advantages.

The above-mentioned properties, features and advantages of the present disclosure, and the manner in which these are achieved, are clarified are further explained in conjunction with the following schematic description of one exemplary embodiment, which is described in greater detail with reference to the drawings.

### BRIEF DESCRIPTION OF THE DRAWINGS

FIG. 1 shows a sketch of a system for executing the method; and

FIG. 2 shows a sketch of a simplified blockchain.

### DETAILED DESCRIPTION OF THE DRAWINGS

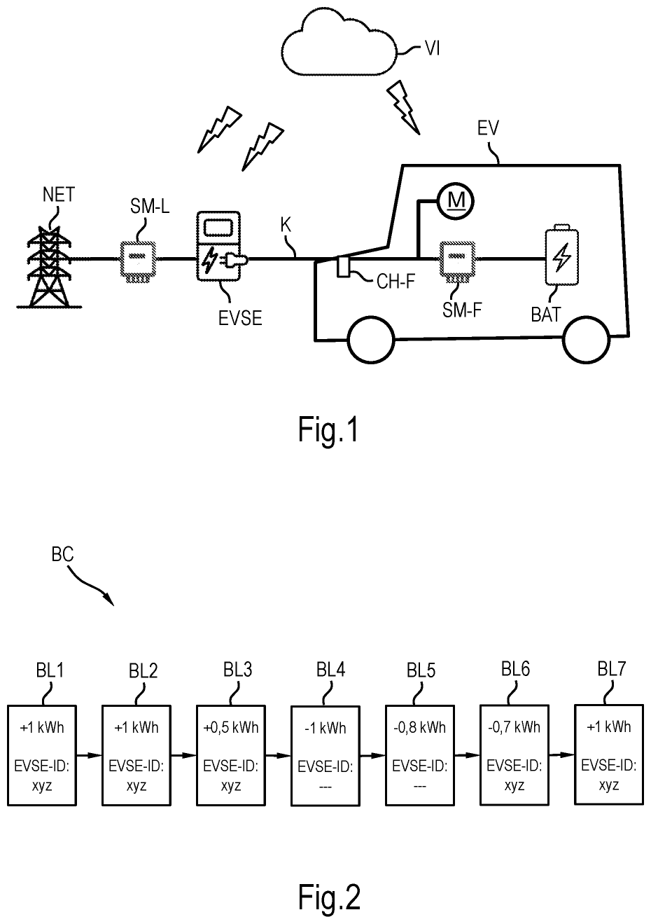

FIG. 1 shows a sketch of a system for executing the present method.

The system comprises a bidirectionally chargeable electric vehicle EV having an electrical energy store BAT and a certified vehicle electricity meter SM-F, which meter is designed for the bidirectional metering of an energy throughput in the energy store BAT, i.e. a. quantity of electrical energy which is charged and discharged. The vehicle electricity meter SM-F is arranged between the energy store BAT and electric loads such as an electric drive motor M, etc., and a charging terminal CH-F. The electric vehicle EV is electrically and communicatively connectable via the charging terminal CH-F, by a cable K, to a charging point EVSE, e.g. in the form of a charging station or wall box, which is designed for the bidirectional charging of the electric vehicle EV. The charging point EVSE is connected via a charging point electricity meter SM-L, e.g. to a public electric power grid NET.

The system further comprises an external billing entity VI which is communicatively connectable at least to the electric vehicle EV and, optionally, also to the charging point EVSE or to the charging point electricity meter SM-L. The billing entity VI is at least designed to receive information with respect to quantitative electrical energy throughputs in the vehicle electricity meter SM-F, and with respect to associated charging connection statuses. On this basis, the billing entity VI can determine and execute the billing of a quantitative energy throughput in the vehicle electricity meter SM-F, according to the usage type thereof thus determined (re-injection into the grid NET, or operation of the electric vehicle EV, or employment for the on-board demand of the electric vehicle EV). In particular, the quantity of energy which is re-injected into the grid NET via the charging point EVSE can be determined such that it is equivalent to the quantity of energy which is discharged from the energy store BAT when the electric vehicle EV is connected to the charging point EVSE on the grounds that, in this case, any driving operation of the electric vehicle EV can be practically excluded. In particular, energy which has been stored in the electric vehicle EV and employed for the operation thereof is billed without deductions. In particular, energy which is employed to serve the interests of the grid or the market is billed subject to the deduction of network access charges, taxes and duties.

To this end, in the present case, directional flow-sensitive metered values of the vehicle electricity meter SM-F which are representative of an energy throughput, together with associated charging connection statuses, are documented in a blockchain BC, and blocks of the blockchain BC are progressively communicated to the billing entity VI. On this basis, the billing entity VI can execute a balancing operation.

FIG. 2 shows a sketch of a simplified blockchain BC having seven blocks BL1 to BL7. In the present context, of the potential information or entries in the blocks BL1 to BL7, only an unequivocal characteristic or identification of the electric vehicle EV (also described as an “EV-ID”), optionally an unequivocal identification of a charging point EVSE to which the electric vehicle EV is connected (also described as an “EVSE-ID”), a direction of energy flow and a quantitative energy throughput are considered. From these entries, an—in particular, encrypted—checksum can be generated.

The blockchain BC represents the following sequence: firstly, the electric vehicle EV having the EV-ID “abc”, on a charging station EVSE having an EVSE-ID “xyz”, is charged with a quantity of energy to the amount of 2.5 kWh, the electric vehicle EV is then driven and consumes 1.8 kWh, and thereafter, upon a further connection thereof to the charging station EVSE “xyz”, 0.7 kWh is firstly re-injected from the drive battery BAT into the electric power grid NET, and 1 kWh of electrical energy is then extracted from the electric power grid NET, such that the drive battery BAT is charged. Blocks BL1 to BL7 are structured such that, for each kWh of energy throughput, one block BL1 to BL7 is generated, provided that no changeover of the charging connection status and/or no changeover of a direction of energy flow occurs, in which case only a proportion of the quantity of energy for the presently open block is balanced, up to the time of the changeover, and the presently open block is then closed.

This sequence generates the following blocks, all of which carry the same EV-ID:
BL1: Quantity of energy “+1 kWh” (corresponding to a charging of the drive battery BAT with 1 kWh of electrical energy at the charging point EVSE), EVSE-ID: “xyz”. The symbol which precedes the quantity of energy indicates the direction of energy flow: “+”=charging of the drive battery BAT, “−”=discharging of the drive battery.
BL2: Quantity of energy “+1 kWh” (corresponding to a charging of the drive battery BAT with 1 kWh of electrical energy at the charging point EVSE), EVSE-ID: “xyz”.
BL3: Quantity of energy “+0.5 kWh” (corresponding to a charging of the drive battery BAT with 0.5 kWh of electrical energy at the charging point EVSE), EVSE-ID: “xyz”.
BL4: Quantity of energy “−1 kWh” (corresponding to a discharge of 1 kWh of electrical energy from the drive battery BAT), EVSE-ID: “--- ” (no connection to a charging point). This corresponds to a usage of electrical energy which is extracted from the drive battery BAT for an operation, in particular for a driving operation, of the electric vehicle EV.
BL5: Quantity of energy “−0.8 kWh” (corresponding to a discharge of 0.8 kWh of electrical energy from the drive battery BAT), EVSE-ID: “--- ” (no connection to a charging point).
BL6: Quantity of energy “−0.7 kWh” (corresponding to a discharge of 0.7 kWh of electrical energy from the drive battery BAT at the charging point EVSE having the EVSE-ID:
“xyz”). This is interpreted as a re-injection into the electric power grid NET.
BL7: Quantity of energy “+1 kWh”, corresponding to a charging of the drive battery BAT with 1 kWh of electrical energy at the charging point EVSE having the EVSE-ID:
“xyz”.

Quantities of energy in blocks BL1 to BL3 and BL7 which are extracted from the electric power grid NET for charging the drive battery BAT can be billed to the user of the electric vehicle EV, together with network access charges, taxes and duties. Energy which is re-injected from the drive battery BAT into the electric power grid NET in block BL6 can be credited to the user of the electric vehicle EV without the application of network access charges, taxes and duties.

Naturally, the present disclosure is not limited to the exemplary embodiment represented.

In general, the article “a”, “an”, etc. can be understood as a singularity or a plurality, particularly within the meaning of “at least one” or “one or more”, etc., provided that this is not explicitly excluded, e.g. by the expression “exactly one”, etc.

Indication of number can also comprise exactly the number indicated, or can incorporate a customary tolerance margin, provided that this is not explicitly excluded.

### LIST OF REFERENCE SYMBOLS

BAT Electrical energy store
BC Blockchain
BL i^{th} block in the blockchain
CH-F Charging terminal
EV Electric vehicle
EVSE Charging point
EVSE-ID Charging point identification
K Charging cable
M Electric drive motor
NET Electric power grid
SM-F Vehicle electricity meter
SM-L Vehicle electricity meter
VI Billing entity

1-12. (canceled)

13. A method for monitoring a use of electric energy stored in an electrical energy store of an electric vehicle, comprising:
monitoring a quantity of electrical energy that is discharged from the electrical energy store and an existing charging connection status to a charging point; and
determining a quantity of energy that is re-injected from the energy store via a charging point,
wherein the quantity of electrical energy which is discharged from the energy store is monitored when the electric vehicle is connected to a charging point.

14. The method according to claim 13,
monitoring the quantity of energy that is injected into the energy store by a vehicle electricity meter of the electric vehicle.

15. The method according to claim 13, comprising:
monitoring the quantity of electrical energy that is discharged from the energy store by a vehicle electricity meter of the electric vehicle that is assigned to the energy store.

16. The method according to claim 15,
wherein the vehicle electricity meter is electrically arranged between the energy store and electric loads of the electric vehicle.

17. The method according to 15, comprising:
transmitting, by the electric vehicle, metered values from the vehicle electricity meter, and the associated charging connection statuses, to an external billing entity.

18. The method according to claim 15, comprising:
in an event of a connection of the electric vehicle to a charging point, monitoring the quantity of energy that is re-injected via the charging point by a charging point electricity meter that is assigned to the charging point;
comparing the quantity of energy that has been discharged from the energy store with the quantity of energy which has been re-injected via the charging point; and
determining a quantity of energy that has been consumed by the electric vehicle in the interim based on the comparing.

19. The method according to claim 17,
documenting metered values from the vehicle electricity meter, together with the associated charging connection statuses, in a blockchain; and
communicating the blocks of the blockchain to the external billing entity.

20. The method according to claim 19, wherein a block contains a proof for a checksum of a content of a preceding block, which checksum is signed by the vehicle electricity meter using a private key thereof.

21. The method according to claim 19,
wherein at least one of the following information is included in a block of the blockchain:
an unequivocal identification of the block;
an unequivocal identification of the electric vehicle and of the vehicle electricity meter;
an unequivocal identification of a charging station to which the electric vehicle is connected;
a term of validity of the block comprising a start time and an end time;
the charging connection status;
the direction of energy flow; and/or
a quantitative energy throughput.

22. The method according to claim 19, comprising:
generating a block in the blockchain for each partially completed and stipulated quantitative unit of energy throughput.

23. The method according to claim 19, comprising:
in an event of a changeover of the charging connection status and/or a changeover in a direction of energy flow:
balancing a quantitative proportion of energy for a presently open block, and
closing the block of the blockchain which is presently open.

24. A system, comprising:
a bidirectionally chargeable electric vehicle having an electrical energy store and a vehicle electricity meter configured to meter at least a quantity of electrical energy that is discharged from the energy store;
a charging point configured to bidirectional charge the electric vehicle;
an external billing entity that is communicatively connectable to the electric vehicle and is configured to:
receive information regarding throughput of quantities of electrical energy in the vehicle electricity meter; and
execute a billing of the quantitative energy throughput in the vehicle electricity meter, according to a type of energy usage specified.
